(19) United States
(12) Patent Application Publication
(10) Pub. No.: US 2010/0167026 A1
(43) Pub. Date: Jul. 1, 2010

(54) DECORATIVE PRODUCTS HAVING DEPTH OF IMAGE

(76) Inventor: Marc A. Hayes, Plymouth, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/523,582

(22) PCT Filed: Jan. 17, 2008
(86) PCT No.: PCT/US2008/000607

§ 371 Date: Jan. 15, 2010

Related U.S. Application Data
(60) Provisional application No. 60/885,308, filed on Jan. 17, 2007.

(51) Int. Cl. B32B 5/08; B29C 45/16

(52) U.S. Cl. 428/196; 264/247; 264/255

(57) ABSTRACT

A method of manufacturing decorative appliqués having a decorative outer layer, a clear backing layer which provides exceptional “depth of image” and a substrate layer is provided. Decorative or protective appliqués' having a wide range of decorative patterns may be formed by injection molding a clear plastic behind the surface of a thin substantially transparent film, fabric or sheet and backing such decorative composites with a substrate layer. The presence of the clear layer behind the relatively transparent decorative layer provides enhanced depth of image to the features of the decorative layer.

### CROSS-REFERENCE TO RELATED APPLICATIONS

The present application claims the benefit of the filing date of U.S. Provisional Application Ser. No. 60/885,308, filed Jan. 17, 2007, the teachings of which are incorporated herein by reference.

### FIELD OF THE INVENTION

This invention relates to plastic composites which may be formed by injection molding, particularly to plastic composites which find use as decorative appliqués for motor vehicle trim, and more particularly, to decorative appliqués which contain a decorative layer and a substantially clear plastic layer and a substrate layer. The appliqués may exhibit a “depth of image” provided by a layer of relatively clear plastic forming a backing layer between the decorative layer and the substrate layer.

### BACKGROUND OF THE INVENTION

Transportation vehicles, particularly automobiles, are marketed and sold on the basis of differentiation over other competitive models. Differentiation may be by style or color, and is often accomplished by using trim panels or appliqués on the interior or exterior of the vehicle which denote different levels of luxury, price or value. These appliqués or panels may also form protective coverings for areas that protrude from adjacent surfaces. These panels are generally color-coordinated with the adjacent surfaces of the vehicle but may also be bright, reflective, wood grained, marbleized or metallized in appearance.

Originally, real wood appliqués and finished metal panels were used, however, their popularity suffered due to their high cost and limited durability. Subsequently, wood veneers and films with vacuum-deposited metal layers found favor, however, these solutions did not produce the look of luxury or the extended durability required in today's market.

Various proposals have been suggested and practiced for the manufacture of plastic composites for use as automotive interior trim and exterior trim panels or appliqués. One approach has been to form a metal or plastic substrate and apply multiple coatings thereon to produce a high gloss Class A-surfaced part. The substrates may be formed from steel, or any one of a wide range of known plastic materials such as ABS, PP, ABS/PC blends, PU, TPO, PET, PBT or other equivalent high strength plastic materials suitable for injection molding into a product shape. The coatings for such substrates may be selected from known coatings such a primer coat, an adhesion promoter, a base coat and a clear coat, and in the case of metals, an electrodeposition coat. Examples of such coatings are set forth in U.S. Pat. Nos. 4,681,811 and 5,320,869. The solvents used in such systems may cause undesirable environmental and emission problems.

Another approach is to form a paint film and inject polymeric material behind the paint film to produce a part with a desired colormatch on its exposed Class A surface. Examples of known paint film and injection molded plastic parts are disclosed in U.S. Pat. Nos. 5,432,666 and 5,009,821. Such systems may require the separate manufacture and handling of the film. Furthermore, the outer surface being a paint film may not exhibit an exceptional depth of image and may be readily scratched or abraded.

Still another approach to providing a colored plastic part is to provide an enamel coating that will reduce emissions while producing a crater resistant surface on the part being coated. One such system is set forth in U.S. Pat. No. 4,396,680. Such systems may require the use of expensive conventional coating systems and baking ovens to form a finish on the substrate that has the desired appearance.

Yet another approach is to provide laminating equipment in which a color layer is formed by extrusion and then connected to a substrate. U.S. Pat. No. 4,349,592 discloses the use of such a technique in the manufacture of a decorative molding exterior trim part.

Various other proposals have been suggested to produce decorative trim parts and appliqués which have unique decorative patterns, high distinctness of image (DOI) and exceptional “depth of image” which give the impression of luxury and high value. “Depth of image” is herein defined as the emphasis of a decorative pattern or color by a preferably clear resin layer, which provides the appearance that the pattern lies deep beneath the top surface of outer layer. This is derived from wood finishing where multiple layers of wax or coatings are applied and buffed out to provide a grain pattern that appears to lie well below the top surface or has depth. DOI may be determined by a test method such as ASTM D5767-95 (2004) wherein a light having a grid pattern is projected onto the surface to be tested and the clarity of the grid pattern is accessed.

U.S. Pat. No. 5,338,592 is directed at laminating a series of wood veneers to form an overlay sheet, finishing, cutting and drying the overlay to form a shape, molding a transparent resin layer onto the front surface of the wooden shape and molding a synthetic resin core material onto the rear surface of a wooden shape. However, the effort of forming the wooden veneer overlay to the desired shape is both time consuming and costly.

Similarly, U.S. Pat. No. 5,525,179 is directed at manufacturing a lining part comprising a blank having a preformed shape and a cutout with an edge, injection molding a first plastic material to form a back surface, followed by injection molding a second plastic material to form a front surface coating which also coats the edges of the part. Again, a preformed shape is disclosed.

As disclosed in the '179 reference, German Published Application 41 24 297 describes a similar process using a preshaped blank and employing polymethyl-methacrylate (PMMA) as the outer layer. However, this reference does not disclose the use of a plastic backing layer.

U.S. Pat. No. 6,444,317 is directed at preparing a laminate film including a polyolefin film layer and a primer layer and injection molding a polyolefin resin onto the polyolefin film layer to form an outer layer.

Regarding decorative wood articles, U.S. Pat. No. 6,444,319 assigned to Erwin Behr, GmbH & Co. is directed at surface coating of an interior fitting for vehicles with a lacquer or resin layer wherein a wood veneer component is inserted into a mold and spaced from the cavity so that a liquid surface coating material having at least two mixed components may be introduced into the space between the mold and wood veneer component. United States Patent Application Publications Nos. 2003/0044598 and 2003/0162045, also to Behr, disclose the use of a liquid coating material curable by UV radiation, and the application of a coating material based on vegetable-oil-modified resin and natural vegetable oils, with the addition to the coating material of ceramic micro- particles, respectively.

Finally, United States Patent Application Publication No. 2002/0007898 is directed at a method of making a molded wood part having a wood grain pattern wherein a wood fiber substrate is formed, coated with a water impermeable substrate and a pattern transferred to the substrate using a hydrographic process. A protective top coat may be applied over the pattern. One example of a hydrographic process is disclosed in U.S. Pat. No. 4,010,057 wherein a thin film on which a pattern is printed is floated on the surface of a liquid and the pattern is transferred onto the surface of the object by submerging the surface of the object in the liquid.

### SUMMARY OF THE INVENTION

The present invention relates to a production method for providing a trim panel or appliqué wherein a decorative layer is positioned in a mold and a substantially clear plastic material is injection molded against the back surface of the decorative layer to form a decorative composite. The clear plastic material may have a depth of greater than or equal to about 1.0 mm. Subsequently, a second plastic material is injection molded against the back side of the clear layer to form a substrate layer.

In another embodiment, the substrate layer may be formed first, followed by the positioning of the decorative layer, and then the clear plastic layer may be injected between the decorative layer and substrate layer. The plastic layer may then tie the substrate layer and decorative layer together.

The plastic materials used for the clear layer and substrate layer may be of the same or different composition, but preferably the first molded layer is a substantially clear transparent plastic which when provided at an appropriate thickness, increases the depth of image of the decorative layer, and the second molded layer is colored to provide a backing and contrast for the decorative composite. The second molded layer may include features (bosses, ribs, holes, etc.) for attachment of the appliqué or trim panel. It is also contemplated that the substrate layer may be a substantially clear layer as well.

The decorative layer may be a relatively transparent or translucent film, a sheet of plastic or a laminate each of which may be colored, tinted, dyed, pigmented and/or printed upon to distinguish its appearance, often with a pattern. The molding process may be carried out using multiple mold cores and covers to form the plastic layers on the back side of the decorative layer. In one exemplary embodiment, the decorative composite may be formed in one mold set and may travel with a first mold cover to subsequently align with a second mold core to provide a cavity space for molding an outer substrate layer against the back side of the clear layer. Alternatively, the decorative composite may be demolded from the first mold set and placed in a second mold set having a cavity space which will allow the molding of the substrate material against the back side of the clear layer.

The injection mold core and cavity may be designed with an extended shear edge which may allow the aligned core and cavity to be separated, after the decorative layer and clear layer have been formed, by an amount substantially equal to the thickness of the substrate layer, to form the final composite structure for an appliqué or trim panel.

It is also an object of the present invention to provide appliqués and trim panels having a relatively transparent decorative layer backed by a substantially clear plastic layer which provides a depth of image or luxurious appearance.

It is a still further object of the present invention to form appliqués and trim panels having a distinctive appearance wherein the relatively transparent decorative layer includes patterns, pigments, metallic flakes, tints, and/or fibers which provide a unique appearance effect.

Another object of the present invention is to provide a tool design for an injection mold whereby an extended shear edge allows the same mold set to be used to provide successive layers of injection molded plastic behind a decorative layer.

It is a further object of the present invention to form appliqués or trim panels having a depth of image wherein the decorative layer is formed to a final shape by the injection molding of the first, preferably clear material, behind it.

Still other objects and advantages of the present invention will become readily apparent to those skilled in the art from the following detailed description, wherein it is shown and described preferred embodiments of the invention. As will be realized the invention is capable of other and different embodiments, and its several details are capable of modification in various respects, without departing from the invention. Accordingly, the description is to be regarded as illustrative in nature and not as restrictive.

### BRIEF DESCRIPTION OF THE DRAWINGS

The features, operation and advantages of the invention may be better understood from the following detailed description of the preferred embodiments taken in conjunction with the attached drawings, in which

FIG. 1 is a perspective view of an automobile instrument panel including an appliqué prepared according to the present invention.

FIG. 2 is a perspective view of an automobile door panel including an appliqué prepared according to the present invention

FIG. 3 is an enlarged cross-sectional view of an appliqué or trim panel of the present invention.

FIG. 4 is a simplified cross-sectional view of an apparatus to form the decorative composite of one embodiment of the present invention.

FIG. 5 is a simplified cross-sectional view of an apparatus to form the appliqué of one embodiment of the present invention.

FIG. 6 is a block diagram reciting the steps of a preferred molding process.

FIG. 7 is a block diagram reciting an alternative molding process.

FIG. 8 is a block diagram reciting still another alternate molding process.

### DETAILED DESCRIPTION

Decorative panels in the form of appliqués and bezels are found in many markets; automotive, appliance, marine, furniture, etc. Some of these panels also function as protective trim strips along the sides of boats and cars to prevent minor bumping damage. These panels may take on any appearance to differentiate the product which they are installed upon. Protective trim appliqués are often bright, reflective metal-appearing laminates or extrusions with a plastic outer layer. The present disclosure provides a molding process for producing thin appliqués having a depth of image when combined with relatively transparent decorative outer layers of film, sheet, etc.

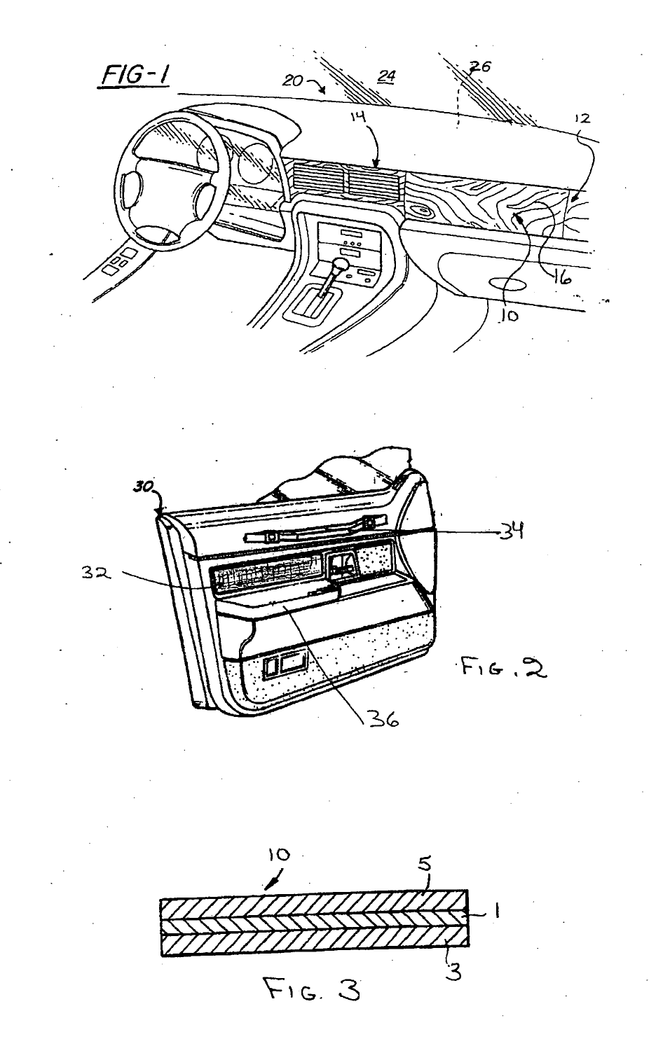

An appliqué of this type is shown at 10 in FIG. 1. FIG. 1 is a perspective view of the driver's side of an automobile cockpit with the main instrument panel 20 shown beneath a windshield 24. Beneath the instrument panel, typically, there may be an airbag deployment system 26 whose presence may be indicated by an air bag door, or as shown in FIG. 1, may comprise a hidden system. Decorating the surface of the instrument panel 20, there may be, for instance, three coordinated appliqués 10, 12 and 14 which include a pattern 16 that may be part of a relatively clear decorative film or sheet. The film or sheet may be colored to provide a coordinated appearance with other articles on the interior of the vehicle. By providing an appliqué with a depth of image, the interior appearance of the vehicle may be enhanced and differentiated and the printed pattern 16 may appear to be suspended deep within the body of the appliqué 10.

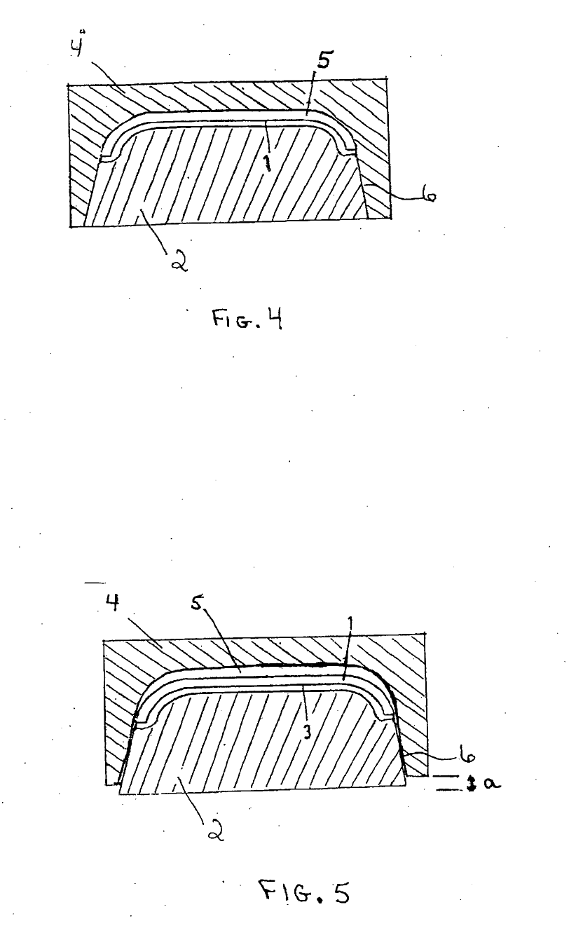

A second decorative appliqué is shown in FIG. 2 where a door panel 30 which includes a grab-handle 34 and armrest 36 further includes a decorative appliqué 32, in this case having the appearance of for instance, an open weave fabric, appearing to be deeply encased in a clear plastic layer. Other applications for the method and construction of the present invention may be equally suitable as protective or decorative strips or panels on the outside of other vehicles, or appliances, etc. or in other markets where a decorative finish exhibiting a high depth of image is important.

The construction of the appliqué or trim panel of the present invention is shown in simplified cross-sectional view in FIG. 3. The layers as shown are exaggerated in thickness for clarity of the discussion. The relative dimensions of the layers may not be as depicted.

Here, an appliqué 10 comprises a decorative layer 5 having a front side and a back side, which may include, but is not limited to, a film, fabric, transparent veneer, coating or thin transparent laminate. This layer may be backed with a layer 1 of a first substantially clear plastic on its back side and further may have a backing layer 3 formed therebehind. The clear layer 1 may preferably be injection molded of a clear plastic at a thickness to provide the desired depth of image and to support the thin decorative layer 5. The substrate layer 3 may also be injection molded and may be of nearly any plastic material. The layer 3 may be tinted, pigmented or otherwise decorated to contrast with the appearance of the clear layer 1, if so desired. Likewise, the top layer 5 may be colored, dyed, tinted, pigmented or otherwise decorated to yield a specific relatively transparent appearance as desired. As noted above, typical decorative materials for the top layer may include, but, are not limited to, open weave cloth or fabrics, colored films, or other relatively transparent constructions.

Films useful in this invention, which are substantially transparent yet may be colored, decorated or printed upon may be obtained from, for instance, Avery Dennison, Shin-Etsu and Delmar Products and may contain particles which may make them sparkle and glitter. These films may have a polymer base including, but not limited to, acrylic, ABS, cellulose nitrate, cellulose acetate, flexible PVC, polyvinylidene difluoride and combinations thereof. The films may be laminates where a printed pattern is disposed on one surface of a first polymeric film and a second layer of plastic formed or applied behind the pattern to protect it from being disturbed during the subsequent molding process.

The present disclosure also provides a process for forming thin appliqués or trim panels. In one exemplary embodiment as shown in FIG. 4, a decorative layer 5 is positioned between mold halves 2, 4. When mold core 2 is aligned with the mold cover 4 there is a resulting cavity space formed for a first clear plastic 1 to be injection molded behind the decorative layer 5. This causes the decorative layer 5 to conform to the shape of the mold cover 4 and for the first clear plastic 1 to fill out the space between the decorative layer 5 and core 2. The core 2 and cover 4 may be aligned by a shear edge 6 which extends around the projected core 2 and closely interfaces with the cover 4. In a preferred embodiment the shear edge 6 is lengthened so that an additional substrate layer 3 may be injected behind the clear layer 1 (see FIG. 5) by withdrawing the core 2 out of the cover 4 by an amount “a” as illustrated. The decorative layer 5 in FIG. 4 may be cut to conform to the dimensions of the space between the core 2 and cover 4 or may extend across the land area of the cover 4 and be held in place, or even cut off by the core 2 along the shear edge 6 when the core 2 and cover 4 are aligned. The decorative layer 5 may also be preformed to the shape of the cavity portion of the mold cover 4 in the case of complex appliqués to provide registration of the decorative layer 5 to the mold cover 4.

The substantially clear layer 1 may comprise any of the relatively clear or light stable, plastics available in the art, including but not limited to, polycarbonate, poly(methylmethacrylate), thermoplastic urethane, polyester, copolyester alloys, cyclic olefin copolymer, poly-4-methyl-1-pentene, polyvinylidene difluoride, polysulphone, allyl diglycol carbonate, allyl ester, styrene-acrylonitrile, polystyrene and polyvinyl chloride. Accordingly, the substantially clear layer herein may be understood to be a layer of material that transmits greater than or equal to about 80% of visible light.

The decorative layer 5 may be held in place in the mold cover by various means prior to injection of the clear plastic layer 1, including, but not limited to, adhesive means, electrostatic attraction and vacuum.

Turning to. FIG. 5, it is shown that the core 2 of FIG. 4 has been retracted out of the cover 4 portion of the mold set by an amount, a, which is preferably substantially equal to the thickness of the substrate layer 3 of the appliqué 10. This allows the substrate layer 3 to be injected behind the decorative composite formed by the decorative layer 5 and clear backing layer 1 without leakage.

The entire appliqué 10 (decorative film, substantially clear material and substrate) as formed by the method of the present disclosure may be of any thickness suitable for the application for which the appliqué is intended. It may have a value of greater than or equal to about 3.0 mm. in thickness, depending on the molding properties of the clear resin used for that layer and the depth of image desired to enhance the appearance of the decorative layer 5. As noted above, it has been found that a thickness of the clear layer may be greater than or equal to about 1.0 mm, and may itself fall in the range of 1.0 mm-2.0 mm, including all values and increments therein.

The substrate layer may include any plastic material and may be colored, pigmented, tinted, etc. to provide a contrast or backing color for the clear overmolded and decorative layers. The substrate layer may also be molded to include any of a variety of attachment means for the appliqué', including but not limited to bosses, hook and loop devices, ribs, inserted molded fasteners and dielocks. Preferably, the decorative layer and backing layers may all be from the same polymer family, such as acrylic, to provide interlayer adhesion.

One benefit to the specific construction and method of the present invention is the ability to mold the appliqué 10 in a single mold set (core 2, cover 4) without having to exchange mold halves to accommodate the outer layer 5. Also of benefit may be the ability to produce relatively thin appliqués, of overall thickness of about 2 mm. by a single injection mold set.

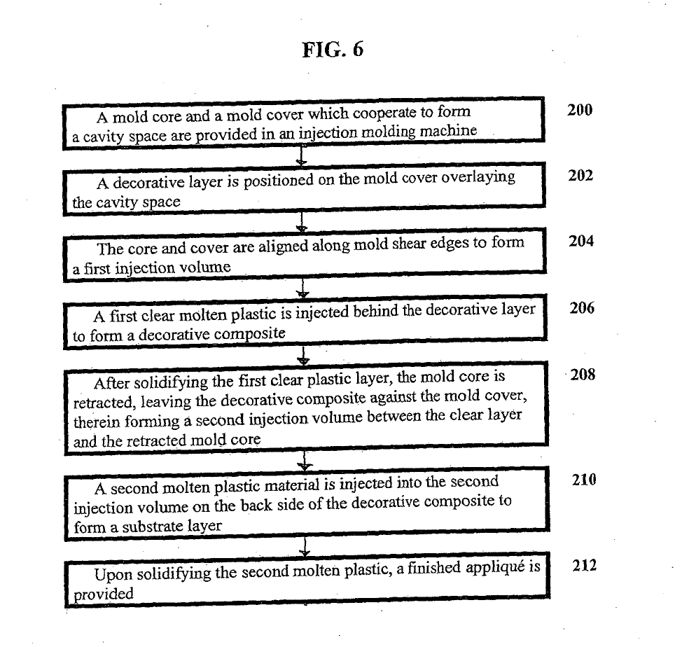

The process of one exemplary embodiment of the present invention preferably comprises (see FIG. 6) the steps of providing a mold core and cover, which cooperate to form a cavity space, in an injection molding machine (Block 200); positioning a, preferably thin, decorative layer 5 across/onto the mold cover 4 which preferably includes a contoured surface (Block 202); aligning the mold core 2, having a contoured surface which mates with, but is spaced from, the contoured surface of the mold cover, with the mold cover 4 to form a first injection volume (Block 204); injecting a first clear plastic as a backing layer 1 on to the back side of the decorative layer 5 and into the injection volume to conform the decorative layer 5 to the cover portion and form a decorative composite (Block 206); solidifying the first clear plastic material and retracting the core 2 from the composite formed by the decorative layer 5 and clear layer 1 (Block 208), which remains with the mold cover 4, along lengthened shear edges which allow the tooling to remain substantially sealed; injecting a second plastic onto the back surface of the clear layer 1 to form a substrate layer 3 (Block 210); solidifying the substrate layer 3 and demolding and trimming the appliqué (Block 212). The invention may also be accomplished by forming the substrate layer first, then retracting the mold core away from the mold cover, inserting the decorative layer 5 across the mold cover, and injecting the clear layer 1 between the substrate layer 3 and the decorative layer 5. Further, it is contemplated that an appliqué' may be similarly formed by co-injecting the two plastic materials on to back side of the decorative layer 5 at substantially the same time by using plastic materials which are dissimilar in polymer type or melt point such that the layers will remain integral and not substantially intermix. A difference in melting point of at least about 5° C. is contemplated.

Appliqués of the present invention may also preferably include fastening means for attachment to other surfaces, including but not limited to, hook and loop, molded bosses which may interact with Palnuts, molded Xmas tree projections, and sections which snap-fit into adjacent or mounting surfaces. Alternately, the fastening features may include dielocks, undercuts and various other male/female features known in the art.

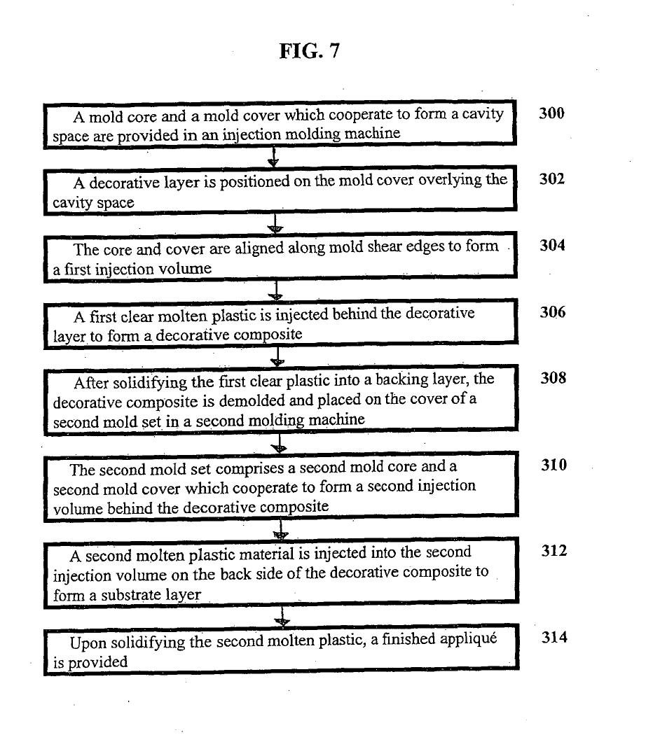

Another method of forming the appliqué of the present invention involves a two-stage process as described in FIG. 7. Here, a first mold core 2 having a contoured projecting portion and a first mold cover 4 having a similarly contoured, preferably recessed, portion spaced from the core may be aligned to form an injection volume for forming a decorative composite layer (Block 300). A decorative layer 5 may be positioned across the mold cover and between the contoured portions of the mold cover 4 and mold core 2 (Block 302), the mold core 2 and cover 4 may be aligned and closed (Block 304) and a first clear plastic material may be injected on to the back side of the decorative layer 5 to form a clear layer 1 (Block 306). Upon solidifying, the decorative composite formed of decorative layer 5 and backing layer 1 may be removed from the molds and placed into a second set of molds comprising core 2A and cover 4A (Block 308). Core 2A and cover 4A cooperate to define a second injection volume between the mold halves which is greater than the volume of the decorative composite (Block 310). A second plastic material may then be injected into the space between the mold core 4A and the decorative composite layer back surface to form a substrate layer 3 (Block 312). Upon solidifying the substrate layer 3, the appliqué 10 may be removed from the mold 2A, 4A and trimmed (Block 314). Alternatively, the substrate layer 3 may be injected first and moved to the second mold set where the clear plastic may be injected between the substrate layer 3 and the decorative film 5.

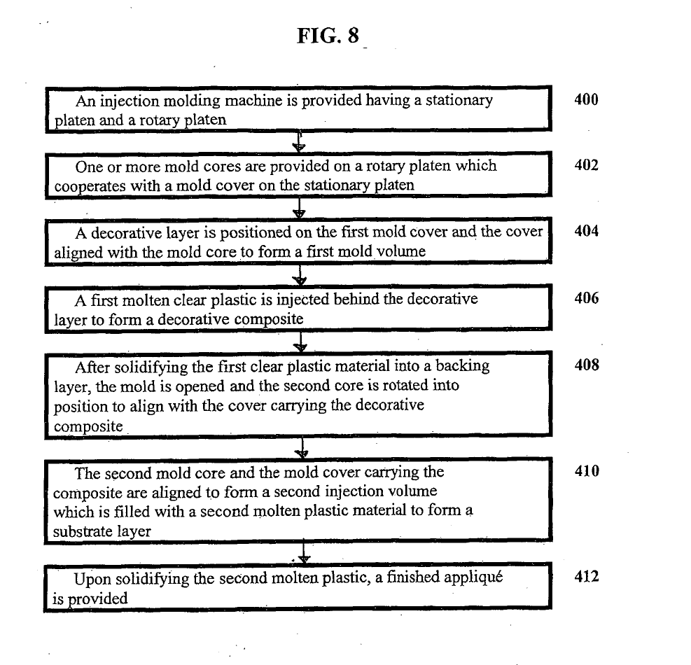

A third method for forming an appliqué is shown in FIG. 8 and includes a two part mold system wherein one of the mold parts may be moveable (Block 400) and includes mold covers having contoured, preferably, cavity portions and the other of the mold parts may be stationary and may include a mold core having a similar contoured surface spaced from the cover. The mold covers and core cooperate to form different injection volumes (Block 402, Block 404) to accommodate injecting a first clear plastic behind a decorative layer using a first mold cover and first mold core (Block 406), and then aligning a second mold cover which provides a larger cavity area with the first mold core (Block 410) including the decorative composite to accommodate the subsequent injection of a substrate layer (Block 410). Upon solidification, the finished appliqué' may be removed (Block 412). The moveable mold parts allow rotation of the mold covers, in this case, to align with the mold core to allow injection of the substrate layer. This is described schematically in FIG. 8. Further, either of the mold parts, cores or covers, may be attached to either of the movable or stationary mold platens. Preferably, the moveable mold part may be carried on a rotary platen that allows the moveable mold part to rotate and align with the stationary mold parts. The moveable mold part may carry the composite laminate from station to station and the stationary mold part may have a profile that allows space for the injection of the subsequent layer to form the finished appliqué.

### EXAMPLE 1

A relatively thin, at least partially transparent decorative film from Avery Dennison, about 0.5 mm. in thickness, was placed between the core and cover of an injection mold for an interior trim appliqué such as shown in FIG. 1. The film comprised an acrylic laminate having a pattern printed on one of the layers, the pattern backed by a second layer of the acrylic such that subsequent over-molding would not disturb the appearance of the pattern.

A clear transparent plastic material, HFI-7 Plexiglas® poly(methylmethacrylate) from Atoglas was injected behind the decorative film to conform the film to the shape of a contoured mold cover and fill out the cavity space between the cover and the mold core to form a clear backing layer. This layer of PMMA was about 1.5 mm. in thickness. After solidifying the clear backing layer, the core portion of the mold set was retracted about 2 mm. with the clear backing layer and decorative layer composite remaining tightly affixed to the mold cover. The resulting cavity space formed by the retraction of the core from the cover was filled with a second colored polymer material, HFI-7 from Atoglas. Upon cooling and demolding the appliqué, a molding having a decorative pattern that appeared to be located deep within a clear transparent layer and having a luxurious appearance was obtained.

### EXAMPLE 2

Using the same mold set up as in Example 1, a preformed section of the same decorative film was positioned between the mold core and mold cover. The film was preformed to have the same contour as the mold cover. The preform was held to the cover of the mold by static attraction and the mold cover registered the pattern in the preform relative to the mold core. MI-7 a poly(methylmethacrylate) was injected behind the preform to force it against the contoured cavity space in the mold cover and back the preform with a clear transparent polymer layer. Upon cooling, the mold cover was retracted along with the combined preform and clear backing layer to form a cavity space for a substrate layer, and a pigmented backing layer of MI-7 was injected into the open space, thus forming a substrate layer behind the decorative composite. Upon cooling and demolding, a unique appearing appliqué was formed having a distinctive pattern which appeared to lie well below the surface of the appliqué', buried deep in a clear layer of polymer.

Accordingly, the present disclosure identifies a relatively thin walled decorative appliqué which may function as a decorative or protective surface or edging. The appliqué may be produced using a molding process whereby a relatively thin decorative layer may be shaped by injecting a first a substantially clear plastic material, as a backing layer, behind the decorative layer, and subsequently injecting a second plastic material on the back side of the clear plastic layer to form an appliqué. Various arrangements of mold alignment are disclosed, although other arrangements are contemplated.

As a second exemplary embodiment, the substrate backing layer may be formed first, a decorative layer place into the mold and then a substantially clear polymer layer injected between the decorative layer and the substrate layer. The appliqué formed by these methods may utilize a relatively wide variety of relatively thin decorative materials that may comprise the decorative layer, by additives in the form of tints, colors, printed patterns, pigments and flakes. All of these additives may be used in the decorative layer. In addition, through the use of a substantially clear polymer as the backing layer behind the decorative layer, a depth of image may be provided to the decorative layer which may further emphasize the appearance of the decorative layer to a given observer.

Variations and modifications are possible without departing from the scope and spirit of the present disclosure.

What is claimed is:

1. A decorative panel, comprising:
a decorative layer which is at least partially transparent or translucent, said decorative layer having a front side and a back side;
a substantially clear plastic backing layer having a first and a second surface, said backing layer formed against said back side of said decorative layer; wherein said decorative layer comprises one of a film, a sheet, a laminate or an open weave fabric.

2. The decorative panel of claim 1 wherein a plastic substrate layer is formed against said second surface of said substantially clear backing layer.

3. The decorative panel of claim 1 wherein said decorative layer is formed to the shape of the decorative panel by said substantially clear backing layer.

4. The decorative panel of claim 1 wherein said film, sheet, laminate or open weave fabric is tinted, colored, dyed, pigmented or printed upon.

5. The decorative panel of claim 1 wherein the composition of said substantially clear plastic backing layer and said plastic substrate layer are substantially the same.

6. The decorative panel of claim 1 wherein said decorative layer includes patterns, metallic flakes, particles or fibers.

7. The decorative panel of claim 1 wherein said substrate layer includes features for attachment of said panel.

8. The decorative panel of claim 1 wherein said panel is an appliqué.

9. A process for providing a decorative panel, comprising:
providing a mold, including a mold core and a mold cover, in an injection molding machine, said mold core and said mold cover cooperating to form a first injection volume;
positioning a decorative layer between said mold core and said mold cover and closing said mold, said decorative layer having a front side and a back side;
injecting a substantially clear plastic material against said back side of said decorative layer to form a backing layer for said decorative layer, wherein said backing layer has a second surface opposite said decorative layer;
solidifying said substantially clear backing layer and opening said mold.

10. The process of claim 9 further including;
forming a second injection volume between said mold core and said second surface of said substantially clear backing layer;
injecting a second plastic material against said second surface of said substantially clear backing layer to form a substrate layer;
solidifying said substrate layer and opening said mold.

11. The process of claim 9 wherein said decorative layer is preformed to the shape of the mold cover.

12. The process of claim 9 wherein said decorative layer is formed to shape by the injection of the substantially clear plastic material against said second surface of said decorative layer.

13. The process of claim 10 wherein said mold core and said mold cover are aligned along a lengthened shear edge to allow the subsequent injection of said second plastic material.

14. The process of claim 10 wherein said substrate layer includes features for attachment of said panel.

15. The process of claim 10 wherein said decorative layer backed by said backing layer is transferred to a second mold for forming said substrate layer.

16. A process for providing a decorative panel, comprising:
providing a mold, including a mold core and a mold cover, in an injection molding machine, said mold core and said mold cover cooperating to form a first injection volume;
injecting a first plastic material into said first injection volume to form a substrate layer;
solidifying said substrate layer and opening said mold;
positioning a decorative layer between said mold cover and said substrate layer and closing said mold to form a second injection volume between said decorative layer and said substrate layer, said decorative layer having a front side and a back side;
injecting a substantially clear plastic material between said back side of said decorative layer and said substrate layer to form a backing layer for said decorative layer;
solidifying said substantially clear backing layer and opening said mold.

17. The process of claim 16 wherein said decorative layer is preformed to the shape of the mold cover.

18. The process of claim 16 wherein said decorative layer is formed to shape by the injection of the substantially clear plastic material against said back side of said decorative layer.

19. The process of claim 16 wherein said mold core and said mold cover are aligned along a lengthened shear edge to allow the subsequent injection of said substantially clear plastic material.

20. The process of claim 16 wherein said substrate layer includes features for attachment of said panel.
